(19) United States
(12) Patent Application Publication
(10) Pub. No.: US 2025/0256302 A1
(43) Pub. Date: Aug. 14, 2025

(54) ULTRASONIC TRANSDUCER FOR HIGH-TEMPERATURE APPLICATION

(71) Applicants: COMMISSARIAT A L'ENERGIE ATOMIQUE ET AUX ENERGIES ALTERNATIVES, Paris (FR); INSTITUT NATIONAL DES SCIENCES APPLIQUEES CENTRE VAL DE LOIRE, Bourges (FR)

(72) Inventors: Frédéric NAVACCHIA, Saint-Paul-Lès-Durance Cedex (FR); Dang Chi NGUYEN, Saint-Paul-Lès-Durance Cedex (FR); Guy FEUILLARD, Bourges (FR); Louis Pascal TRAN HUU HUE, Bourges (FR)

(73) Assignees: COMMISSARIAT A L'ENERGIE ATOMIQUE ET AUX ENERGIES ALTERNATIVES, Paris (FR); INSTITUT NATIONAL DES SCIENCES APPLIQUEES CENTRE VAL DE LOIRE, Bourges (FR)

(21) Appl. No.: 18/878,183

(22) PCT Filed: Jun. 21, 2023
(86) PCT No.: PCT/EP2023/066838

§ 371 Date: Dec. 23, 2024

(30) Foreign Application Priority Data
Jun. 23, 2022 (FR) FR2206279

(51) Int. Cl. B06B 1/06

(52) U.S. Cl. CPC B06B 1/0662

(57) ABSTRACT

An acoustic transducing device includes: a piezoelectric converter interposed between a front electrode and a rear electrode, the piezoelectric converter being formed from a piezoelectric material; a front aperture arranged in such a way that the front electrode is placed between the piezoelectric material and the front aperture; and a rear component, applied against the rear electrode or forming the rear electrode, the rear component forming an acoustic backing element of the device. The device is configured to transmit an acoustic wave to the front aperture or to detect an acoustic wave propagating from the front aperture. The rear component includes a porous metal having a melting point greater than 200° C.

### TECHNICAL FIELD

The invention relates to an acoustic transducer intended for use in non-destructive testing, obstacle-detection, range-finding, etc. operations in environments that may be at high temperatures and high pressures, in a nuclear power plant for example.

### PRIOR ART

Ultrasonic non-destructive testing is well suited for monitoring structures, so as to track resistance to ageing and the appearance of any defects, or for range-finding or obstacle-detection operations. Certain applications are performed in high-temperature and/or high-pressure environments. This is for example the case in the field of aircraft engines, or in the petroleum industry, or in nuclear reactors.

FIG. 1A schematically shows a prior-art ultrasonic transducer 1_{AA} intended to be used in a high-temperature environment. By high temperature, what is generally meant is a temperature greater than 200° C., or greater than 600° C. The active elements of the transducer are placed in a housing 2. The active elements comprise a piezoelectric converter 10, formed from a piezoelectric material, interposed between a front electrode 11 and a rear electrode 12. Each electrode is connected to one electric circuit 20. The front electrode is placed facing an inlet aperture 15 formed in the housing 2. Such an architecture is described in US2014215784.

Under the effect of the application of an alternating voltage between the electrodes, the piezoelectric converter generates an acoustic wave EW. The transmitted acoustic wave EW propagates to an external medium 3 outside the enclosure 2, through the aperture 15. The transducer may comprise a plate 14 allowing acoustic impedance matching between the transducer and the external medium 3. The transducer thus operates in a transmission mode.

The transducer may also operate in a reception mode, in which an acoustic wave RW propagates from the external medium 3 to the transducer. The received acoustic wave RW causes a vibration of the piezoelectric converter. As a result, an alternating voltage appears across the terminals of the electrodes 11 and 12. The transducer thus operates in a reception mode.

For high-temperature applications, the piezoelectric material may be lithium niobate, as described in patent U.S. Pat. No. 9,425,384.

FIG. 1B shows a timing diagram of the amplitude of vibration of a prior-art electric transducer, following reception of an acoustic wave. The y-axis corresponds to the amplitude of the vibration wave of the piezoelectric converter, as measured by the electric circuit, while the x-axis corresponds to time. Transmission is triggered by applying an alternating voltage for a few microseconds to a few tens of microseconds. However, the vibration of the piezoelectric converter continues for a much longer period of time, of the order of a few hundred us (microseconds). This results in a degradation of the performance of the transducer.

In order to address this problem, it is known to connect the rear electrode to an element forming a damping backing, usually called the backing element. The main function of the backing element is to attenuate, at the rear electrode, vibration of the assembly formed by the piezoelectric converter and the electrodes. In the prior art, the backing element of a transducer may be formed from a polymer doped with high-density particles, for example particles of tungsten or lead. The expression “particulate composite” is also used. The random distribution of particles induces multiple reflections and the acoustic wave attenuates as a result of destructive interference. This makes it possible to decrease the duration of the acoustic pulse of the transducer. However, such a composition is unsuitable for high-temperature applications.

The publication “Porous ceramics as backing element for high temperature transducers”, IEEE Transactions on Ultrasonics, Ferroelectrics and Frequency Control, vol. 62, n°12, pp 360-372, 2015, describes a transducer intended for use at high temperature. The transducer comprises a backing element, which is connected to an electrode and made of a porous ceramic. Use of a ceramic makes it possible to achieve compatibility with implementation at high temperature. However, manufacture of such a transducer requires the ceramic, forming the backing element, to be joined to the electrode. Uncertainty remains as to the durability of such a joint. The resistance of porous ceramics to exposure to high radiation is also uncertain.

WO2016/124941 describes a device for transmitting an acoustic wave comprising a backing element formed from a metal foam.

The inventors have developed an ultrasonic transducer intended to be used under high radiation conditions and at high temperature, or exposed to high temperature gradients, for long operating times, i.e. times longer than a few years, or even a few decades.

### SUMMARY OF THE INVENTION

A first subject of the invention is an acoustic transducing device, comprising
a piezoelectric converter, formed from a piezoelectric material, interposed between a front electrode and a rear electrode;
a housing, containing the piezoelectric converter, the front electrode and the rear electrode;
a front aperture, formed in the housing, and arranged in such a way that the front electrode is placed between the piezoelectric material and the front aperture;
   the device being configured to transmit an acoustic wave to the front aperture or to detect an acoustic wave propagating from the front aperture;
   the device comprising a rear component, applied against the rear electrode or forming the rear electrode, the rear component forming a backing element of the device, the device being characterized in that the rear component is a porous metallic material, the melting point of which is greater than 200° C.

The device may have one of the following features, implemented alone or in any technically feasible combination.
the rear component forms the rear electrode;
the melting point of the metallic material is greater than 600° C.;
the piezoelectric material has a Curie temperature and the melting point of the metallic material is greater than the Curie temperature of the piezoelectric material;
the Curie temperature of the piezoelectric material is greater than 1000° C.;
the volume fraction of the pores of the porous metallic material is between 20% and 60% or between 25% and 50% or between 25% and 40%;
the pores are filled with air;
the average size of the pores is less than 100 μm, the average size corresponding to an average diameter of each pore;
the piezoelectric material is selected from lithium niobate and barium titanate;
the metallic material comprises at least one element selected from: Ni, Fe, Pd, Ag, Au, Cu, Pd, Al.
the metallic material is a stainless steel alloy.

Another subject of the invention is the use of a device according to the first subject of the invention to transmit or receive an acoustic wave, the transmitted or received acoustic wave propagating through the aperture, the device being placed in a medium, the temperature of which is greater than 200° C.

The invention will be better understood upon reading the disclosure of the examples of embodiments which are presented, in the remainder of the description, in connection with the figures listed below.

### FIGURES

FIG. 1A schematically shows a transducer according to the prior art.

FIG. 1B shows a vibration of a transducer.

FIG. 2A shows a first embodiment of a transducer according to the invention.

FIG. 2B shows a second embodiment of a transducer according to the invention.

FIG. 3A schematically shows a poor impedance match between a piezoelectric converter and a component forming a backing element, joined to the converter.

FIG. 3B schematically shows a good impedance match between a piezoelectric converter and a component forming a backing element, joined to the converter.

FIG. 4 schematically shows a test bench, aiming to determine the propagation speed of an acoustic wave through various materials.

FIGS. 5A and 5B show detection echograms obtained with the test bench schematically shown in FIG. 4, in the presence and absence of a studied sample, respectively.

FIG. 6A shows the propagation speed (or just speed) of an acoustic wave (y-axis-unit m.s⁻¹) as a function of the pore volume fraction (x-axis-%).

FIG. 6B shows the acoustic impedance of a porous stainless steel material (y-axis-unit Rayls×10⁷) as a function of the pore volume fraction (x-axis-%).

FIG. 6C shows a linear attenuation coefficient (y-axis-unit dB/mm) as a function of the pore volume fraction (x-axis-%).

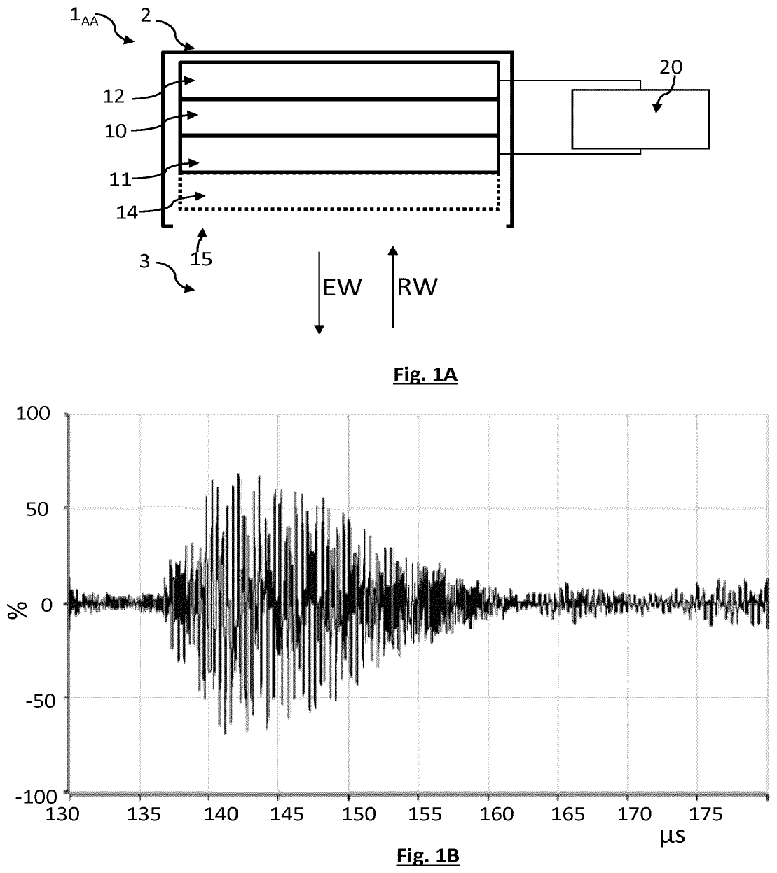

### DESCRIPTION OF PARTICULAR EMBODIMENTS

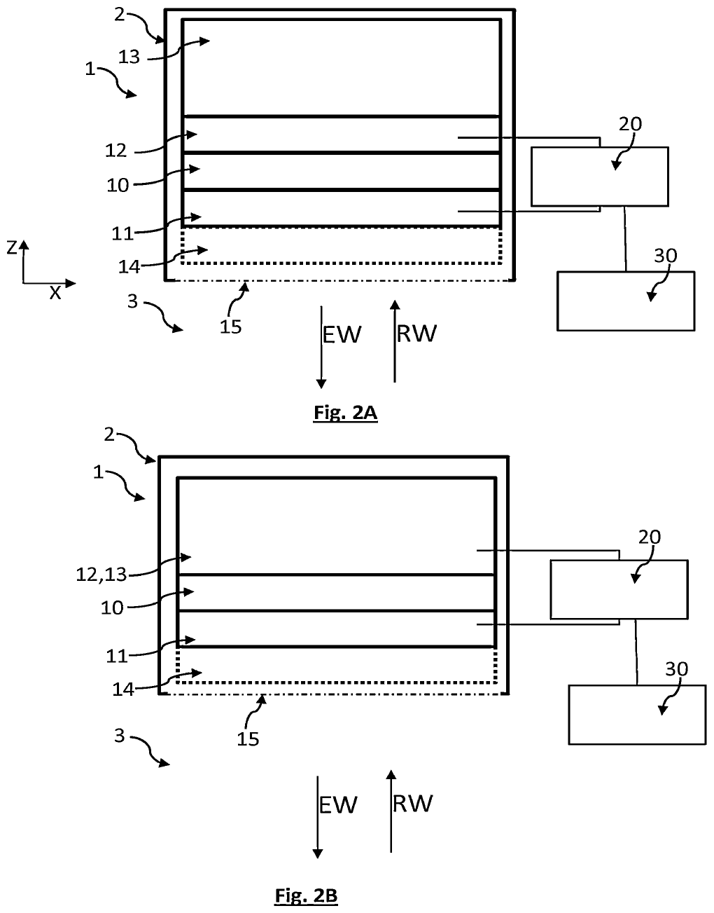

FIG. 2A illustrates a first embodiment of a transducer 1 according to the invention. As described in connection with the prior art, the transducer comprises a converter 10 formed by a piezoelectric material, interposed between a front electrode 11 and a rear electrode 12. The assembly, formed by the piezoelectric converter 10, the front electrode and the rear electrode, is placed in a housing 2 comprising an aperture 15. The front electrode 11 lies between the aperture 15 and the piezoelectric converter 10. The device preferably comprises an acoustic impedance-matching plate 14, interposed between the front electrode 11 and the aperture 15. The impedance-matching plate is for example formed from aluminium.

The transducer is connected to an electric circuit 20, making it possible to apply or measure an alternating voltage between the front electrode and the rear electrode. As described in connection with the prior art, under the effect of application of a brief alternating voltage, an acoustic wave EW is transmitted through the aperture 15, and propagates through an ambient medium 3. The ambient medium may in particular be liquid or solid. It may be water, a liquid material or a solid material. Under the effect of reception of an acoustic wave RW, an alternating electric signal is detected by the electric circuit 20, the amplitude of which signal corresponds to the amplitude of vibration of the piezoelectric converter under the effect of reception of the acoustic wave RW.

The piezoelectric converter 10 may take the form of a disc that has a thickness of 1 mm, and a diameter between 5 mm and 50 mm. The material used is compatible with use at high temperature, for example between 200° C. and 700° C., or even higher, for example above 1000° C. The piezoelectric material may be lithium niobate (LiNbO₃). The resonant frequency of the piezoelectric converter may be from a few hundred kHz to several MHz, for example 4 MHz or 5 MHz. The thickness of each electrode may be of the order of 1 mm. Each electrode may take the form of a disc, the diameter of which corresponds to the diameter of the piezoelectric converter 10.

The electric circuit 20 is connected to a central unit 30, configured to control the electric circuit when the transducer is operating in transmission mode and/or to analyse the voltage measured across the electrodes when the transducer is operating in reception mode.

The transducer 1 comprises a rear component 13, applied against the rear electrode 12. The rear component is intended to form a “backing element” with respect to the piezoelectric converter 10. As mentioned in the prior art, it is a question of attenuating the echoes of the acoustic wave transmitted to the rear of the piezoelectric converter. The thickness of the backing element is preferably greater than 5 mm, or even 10 mm. It may be between 10 mm and 100 mm, 40 mm for example.

One important aspect of the invention is that the backing element 13 is formed by a porous metallic material (a pure metal or metal alloy), the melting point of which is greater than 200° C., preferably greater than 600° C. or 700° C., and preferably greater than 1000° C. It may for example be steel, stainless steel for example, or aluminium, or a metal selected from: Ni, Fe, Pd, Ag, Au, Cu, Pd, Al. It may be a metal alloy such as bronze or brass. The backing element may be formed from the same material as the rear electrode, this making it easier to join them.

One advantage of the metallic material, in particular stainless steel, is its good resistance to corrosion and to ionising radiation (in particular neutrons or gamma radiation), making it compatible with use in a nuclear power plant.

When the backing element is formed from the same material as the rear electrode, in the present case a conductive metal, a phase of joining the backing to the electrode is avoided. Conversely, when the backing element is made of a ceramic, an adhesive or braze must be used to join them. Such a joint may not be durable, especially when the transducer is subjected to high thermal gradients. Specifically, the respective coefficients of thermal expansion of a ceramic and of a metal electrode are generally different from each other. This may lead to degradation of the joint over time, in particular on repeated exposure to high thermal gradients.

The material forming the piezoelectric converter 10 has a Curie temperature, above which its piezoelectric behaviour is considered to disappear. It is preferable for the melting point of the metallic material forming the backing element to be greater than the Curie temperature of the piezoelectric converter. Lithium niobate has a Curie temperature greater than 1100° C.

Use of an electrically conductive metallic material is advantageous. FIG. 2B schematically shows an embodiment in which the backing element and the rear electrode form the same part. Thus, the rear electrode is formed from the electrically conductive porous metallic material. Such an embodiment is particularly advantageous because it minimises the number of parts forming the transducer, and simplifies manufacture, in particular by avoiding the need to join the backing element to the electrode.

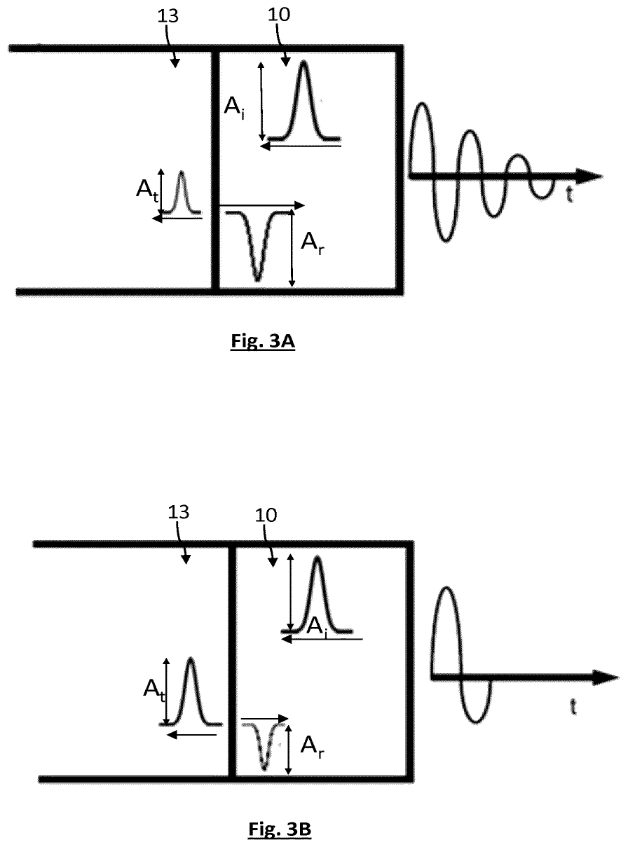

The backing element 13 is configured to maximise transmission of a vibration wave produced by the piezoelectric transducer, and to minimise reflection of said wave. FIGS. 3A and 3B show a configuration such as shown in FIG. 2B, in which configuration the piezoelectric converter 10 is placed directly in contact with the backing element 13, the latter acting as rear electrode. At the interface between the piezoelectric converter 10 and the backing element 13, it is possible to define a transmission coefficient T and a reflection coefficient R. The transmission coefficient T corresponds to a ratio between
the amplitude of a wave, called the incident wave, propagating from the piezoelectric converter 10 and incident on the backing element 13, this amplitude being denoted Aᵢ in FIGS. 3A and 3B;
the amplitude of a transmitted wave Aₜ, which corresponds to the part of the incident wave propagating through the backing element.

The reflection coefficient R corresponds to a ratio between:
the amplitude of the incident wave Aᵢ;
the amplitude of a reflected wave Aᵣ, which corresponds to the part of the incident wave reflected by the backing element 13 and propagating to the piezoelectric converter 10.

If Z₁ and Z₂ designate the acoustic impedances of the piezoelectric converter 10 and of the backing element 13, respectively, the coefficients R and T are such that:

$$R + T = 1 \qquad ( 1 )$$

$$R = \frac{{Z}_{2} - {Z}_{1}}{{Z}_{1} + {Z}_{2}} \qquad ( 2 )$$

$$T = \frac{2 {Z}_{2}}{{Z}_{1} + {Z}_{2}} \qquad ( 3 )$$

FIG. 3A schematically shows a configuration in which the reflection coefficient is, in absolute value, high and the transmission coefficient is low. It is an unmatched configuration: reflection of the incident wave at the interface between the piezoelectric converter 10 and the backing element 13 generates echoes that increase the duration of the acoustic wave transmitted or received by the transducer. This results in temporal degradation of the measurement, in the sense that the times of transmission or reception of the wave are determined with decreased accuracy. When the transducer is used for range-finding purposes, the spatial resolution of the measurement is degraded.

FIG. 3B schematically shows a configuration in which the reflection coefficient is close to 0 and the transmission coefficient is close to 1, this corresponding to an ideal case. Formation of echoes at the interface between the piezoelectric converter 10 and the backing element 13 is weak. This results in a shorter transmitted (or detected) acoustic wave, improving the temporal resolution of the measurement. The aim of the invention is to get closer to this configuration. Expression (3) shows that such a configuration is obtained if the acoustic impedances of the two contiguous media are close to each other, or in other words Z₁˜Z₂.

The acoustic impedance of the piezoelectric converter 10 is generally a few tens of MRayls, and typically between 25 and 40 MRayls (mega rayls), compared with the acoustic impedance of air, which is 430 Rayls or that of water, which is 1.5 MRayls. The configuration shown in FIG. 3A corresponds to an interface between the piezoelectric converter and air. The configuration shown in FIG. 3B corresponds to a desired interface between the piezoelectric converter and porous metallic backing element.

In addition to having a transmission coefficient close to 1, the porous metallic backing element must attenuate the transmitted acoustic wave.

The acoustic impedance and attenuation of the backing element 13 are controlled by the size and volume fraction of the air-filled pores. Various experimental trials have been carried out to define ranges of pore sizes and volume fractions allowing a transmission coefficient close to 1 and a sufficient attenuation to be obtained. It will be noted that the effect, on impedance, of pore size and volume fraction depends on the material used. The values obtained with one material are not transferable to another material.

A key parameter is the speed c of acoustic propagation, from which acoustic impedance Z may be calculated using the expression:

$$Z = ρ c \qquad ( 4 )$$

where ρ is the density of the metallic material, expressed in kg.m⁻³ and c is expressed in m.s⁻¹

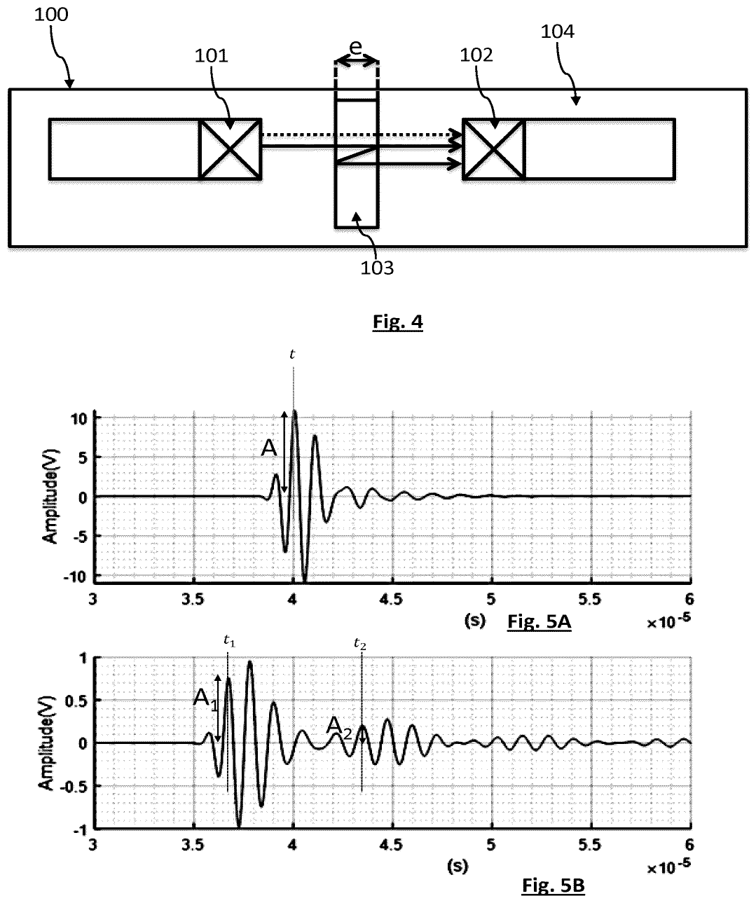

FIG. 4 schematically shows an echometry test bench 100. Metal samples 103 of various porosities were placed between an acoustic transmitter 101 and an acoustic receiver 102. The whole lot was submerged in water 104.

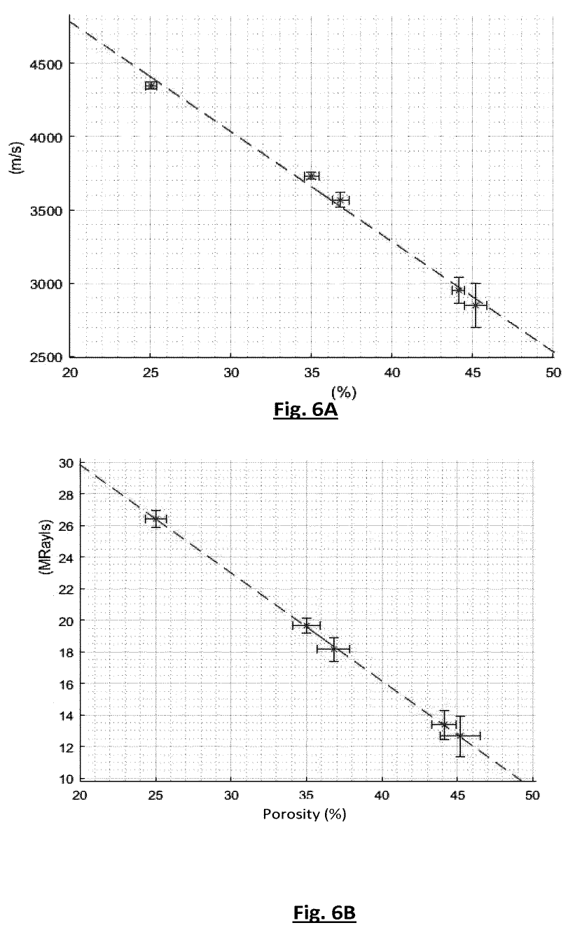

FIG. 5A shows a pulse received by the acoustic receiver 102 without a sample between the transmitter and the receiver. t corresponds to a detection time of the acoustic wave. The y-axis corresponds to amplitude and the x-axis corresponds to time. The propagation of the acoustic wave through the water 104 has been represented by a dotted arrow.

FIG. 5B shows the pulses received by the acoustic receiver 102 after a sample 103, of thickness e, has been placed between the transmitter and the receiver. The y-axis corresponds to amplitude and the x-axis corresponds to time. The propagation of the acoustic wave through the water 104 has been represented by a solid arrow. Given the interfaces formed by the sample 103, two pulses are detected: a first pulse, at the time t₁, corresponds to the wave having propagated through the sample, without reflection. With respect to the time of transmission of the acoustic wave by the transmitter 101, the time t₁ is earlier than the time t, because the speed of propagation of the acoustic wave is greater in the sample 103 than in the water 104.

Based on these measurements, the speed of acoustic propagation (or just speed) c may be defined as follows:
based on Δt=t₁−t, using the expression:

$$Δ t = e ( \frac{1}{c} - \frac{1}{{c}_{w}} ) \qquad ( 5 )$$

based on Δt₁₂=t₂−t₁, using the expression:

$$Δ {t}_{12} = \frac{2 e}{c} \qquad ( 6 )$$

In (5), c_{w} designates the speed of acoustic propagation in water.

Samples of 316L stainless steel of varying thicknesses e (5 mm or 10 mm), having various porosity volume fractions (between 25% and 53%) and various average pore sizes (average diameter between 2 μm and 60 μm) were tested. The table below collates the characteristics of the tested samples. Each sample 103 took the form of a plate measuring 50 mm by 50 mm.

The porosity volume fraction of each sample was determined by measuring the mass per unit volume. The average pore sizes were determined by optical microscopy. Table 1 shows the main characteristics of the tested samples.

TABLE 1

| | Average | | |
|---|---|---|---|
| | thickness | | Average pore |
| Reference | (mm) | Porosity (%) | diameter (μm) |
| 02-10 | 10.00 | 25.20 | 1.7 |
| 05-10 | 10.30 | 36.91 | 7.6 |
| 10-10 | 10.10 | 34.97 | 10.9 |
| 15-10 | 9.90 | 44.12 | 13.5 |
| 25-10 | 9.90 | 45.14 | 26.5 |
| 40-10 | 10.30 | 52.75 | 39.0 |
| 60-05 | 5.10 | 52.95 | 59.5 |

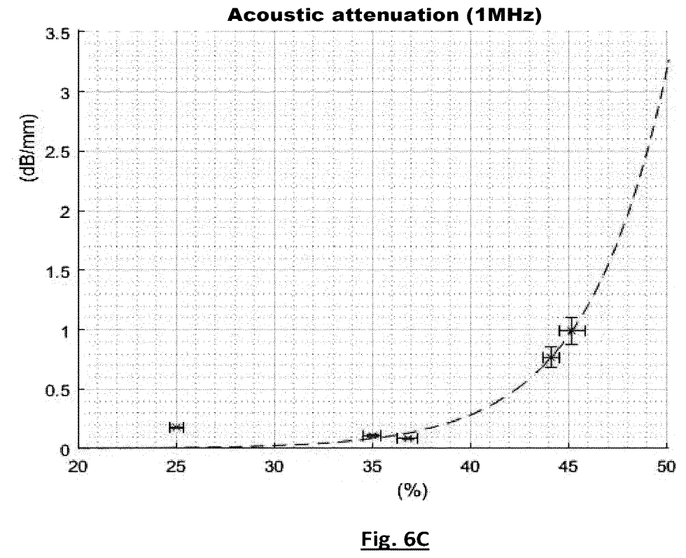

FIG. 6A shows the propagation speeds of the acoustic wave determined using expression (6), as a function of the porosity volume fraction. In FIG. 6A, the y-axis corresponds to speed (unit m.s⁻¹) and the x-axis corresponds to porosity (%).

FIG. 6B shows the acoustic impedance, calculated using (4), based on knowledge of the density ρ of the tested materials and on the speeds obtained using expression (6). The y-axis corresponds to speed (unit m/s) and the x-axis corresponds to the pore volume fraction (%).

A linear attenuation coefficient α (in dB/mm) was also determined from the maximum amplitudes of the waves detected by the receiver 102. Attenuation was measured by comparing the amplitudes of the pulses detected at the times t₁ and t₂ defined with reference to FIG. 6B, respectively.

$$Att = 10 log ( \frac{{A}_{1}}{{A}_{2}} ) \qquad ( 7 )$$

From the attenuations Attₐ and Att_{b} calculated for each sample, a linear attenuation coefficient, per millimetre, denoted a, was determined taking into account:
the thickness of the sample e when considering Attₐ;
twice the thickness e of the sample when considering Att_{b}.

FIG. 6C shows the attenuation coefficients α obtained using expression (7). The y-axis corresponds to attenuation (unit dB/mm) and the x-axis corresponds to the pore volume fraction (%).

In FIGS. 6A and 6C, each point corresponds to one measured value. A function resulting from interpolation of each measurement point has also been plotted with a dashed line. In FIGS. 6A and 6B, the interpolation is linear. In FIG. 6C, the function resulting from the interpolation is a polynomial.

FIG. 6B defines a range of porosity volume fractions, expressed in %, for which the impedance is sufficiently close to the impedance of the piezoelectric material, i.e. in the range 10-40 MRayls. According to FIG. 6B, this corresponds to a porosity volume fraction less than 50%.

FIG. 6C defines a range of porosity volume fractions, expressed in %, for which the attenuation is sufficient. By sufficient attenuation, what is meant is an attenuation coefficient α greater than or equal to 1 dB/mm. According to FIG. 6C, this corresponds to a porosity volume fraction greater than 25%.

The optimum porosity range is that in which:
the impedance of the porous metallic material forming the backing element is sufficiently high (close to the impedance of the piezoelectric material), bearing in mind that impedance decreases with the porosity volume fraction: see FIG. 6B;
attenuation is sufficiently high, bearing in mind that the linear attenuation coefficient α increases with the porosity volume fraction: see FIG. 6C.

It will be understood from the above that the attenuation effect is due to the presence of pores, while the impedance-matching effect is due to the metal. The porosity characteristics of the metal are therefore the result of a compromise in respect of the pore volume fraction.

For 316L stainless steel, taking into account a pore size (i.e. average diameter) of between 2 μm and 60 μm, the optimum range of porosity volume fraction is between 25% and 50%.

The optimum range of porosity volume fraction may be different for another material. Generally, the characteristics of the porous metallic material forming the backing element 13 of the transducer are:
an average pore diameter less than 500 μm, and less than 200 μm or 100 μm;
and/or a porosity volume fraction between 20% and 60%, and preferably between 25% and 50%, and more preferably between 25% and 40%.

In the embodiment described above, the piezoelectric material forming the converter is made of lithium niobate. Other piezoelectric materials suitable for high-temperature environments are usable, for example barium titanate (BaTiO₃), bismuth titanate (BiTiO₃) and its derivatives (addition of sodium for example), aluminium nitride (AIN), the langatates (oxides of lanthanum, gallium and tantalum).

The transducer according to the invention may be used in any high-temperature application, for the purposes of non-destructive testing or of diagnostics or of range finding or of obstacle detection or of flow measurement.

In the claims:

1-11. (canceled)

12. An acoustic transducer, comprising
a piezoelectric converter, formed from a piezoelectric material, interposed between a front electrode and a rear electrode;
a housing, containing the piezoelectric converter, the front electrode and the rear electrode;
a front aperture, formed in the housing, and arranged in such a way that the front electrode is placed between the piezoelectric material and the front aperture;
the acoustic transducer being configured to transmit an acoustic wave to the front aperture or to detect an acoustic wave propagating from the front aperture;
the acoustic transducer comprising a rear component, the rear component forming a backing element of the device,
wherein the rear component is a porous metallic material, the melting point of which greater than 200° C.;
wherein:
the rear component forms the rear electrode;
the thickness of the rear component is greater than 5 mm.

13. The acoustic transducer according to claim 12, wherein a thickness of the rear component is greater than 10 mm.

14. The acoustic transducer according to claim 12, wherein the melting point of the metallic material is greater than 600° C.

15. The acoustic transducer according to claim 12, wherein:
the piezoelectric material has a Curie temperature;
the melting point of the metallic material is greater than the Curie temperature of the piezoelectric material.

16. The acoustic transducer according to claim 15, wherein the Curie temperature of the piezoelectric material is greater than 1000° C.

17. The acoustic transducer according to claim 12, wherein the volume fraction of the pores of the porous metallic material is between 20% and 60% or between 25% and 50% or between 25% and 40%.

18. The acoustic transducer according to claim 12, wherein an average size of the pores is less than 100 μm, the average size corresponding to an average diameter of each pore.

19. The acoustic transducer according to claim 12, wherein the piezoelectric material is selected from lithium niobate and barium titanate.

20. The acoustic transducer according to claim 12, wherein the metallic material comprises at least one element selected from Ni, Fe, Pd, Ag, Au, Cu, Pd, Al.

21. The acoustic transducer according to claim 12, wherein the metallic material is a stainless steel alloy.

22. Use of the acoustic transducer according to claim 12 to transmit or receive an acoustic wave, the transmitted or received acoustic wave propagating through the aperture, the device being placed in a medium, the temperature of which is greater than 200° C.
